(19) United States
(12) Patent Application Publication
(10) Pub. No.: US 2025/0015584 A1
(43) Pub. Date: Jan. 9, 2025

(54) Electronic circuit breaker and circuit arrangement with an electronic circuit breaker

(71) Applicant: Murrelektronik GmbH, Oppenweiler (DE)

(72) Inventors: Hangwen Pan, Backnang (DE); Marcel Manhalter, Sulzbach an der Murr (DE); Nils Matheis, Auenwald (DE)

(73) Assignee: Murrelektronik GmbH, Oppenweiler (DE)

(21) Appl. No.: 18/762,727

(22) Filed: Jul. 3, 2024

(30) Foreign Application Priority Data
Jul. 5, 2023 (EP) 23183616.4

(51) Int. Cl. H02H 3/08

(52) U.S. Cl. CPC H02H 3/08

(57) ABSTRACT

An electronic circuit breaker has an input and an output. A switch is arranged in a current path between the input and the output. A control unit controls the switch between an open state and a closed state. An energy storage device is electrically connected to the current path. When the electronic circuit breaker is arranged in a circuit for passing a load current through the current path, a charge signal is transmitted to the control unit, the change of which correlates with a change in the charge of the energy storage device. The control unit measures a discharge time of the energy storage device using the charge signal. The control unit switches the switch to the open state when a limit value for the discharge time is exceeded, thereby preventing the formation of an arc fault in the circuit.

### CROSS-REFERENCE TO RELATED APPLICATION

This application claims the benefit of European Patent Application EP 23183616.4, filed on Jul. 5, 2023, the contents of which is incorporated in its entirety.

### TECHNICAL FIELD

The disclosure relates to an electronic circuit breaker, and more specifically to an electronic arc fault circuit interrupter.

### BACKGROUND

DE 10 2011 120 466 A1 discloses an electronic circuit breaker for protecting electrical loads arranged in an electrical circuit in the event of a defect, for example in the event of a short circuit.

During normal operation of an electrical circuit, a so-called arc fault (AF) can occur as a result of defective insulation or a break in an electrical cable (cable for short) between a voltage source and an electrical consumer (load for short), as well as due to a loose contact between the voltage source and the load. The voltage source can be a power supply, a battery, an output from a busbar or a similar component for supplying electrical power. The arc fault can not only damage or destroy components of the electrical circuit but can even cause injuries to persons or a fire with significantly worse consequences. In this respect, there is a need for electronic circuit breakers that reduce the risk of arc faults.

### SUMMARY

The present application discloses an improved electronic circuit breaker that can prevent the occurrence of an arc fault in the circuit during normal operation of the circuit.

This is achieved by an electronic circuit breaker that comprises an input and an output. A current path for a load current runs between the input and the output. A switch having a closed state and an open state is arranged in the current path. In the open state, the switch interrupts the current path, preventing the flow of load current. In the closed state, the current path is closed and allows the load current to flow. The switch may be embodied as a metal oxide semiconductor field effect transistor (MOSFET), an insulated gate bipolar transistor (IGBT), a solid-state relay, an electromagnetically, electrothermally, or electromotively actuated mechanical switch, or a hybrid combination thereof.

The electronic circuit breaker further comprises a control unit. The control unit is configured to switch the switch between the open state and the closed state. When the electronic circuit breaker is operating as intended, an input voltage Uᵢₙ is present at the input.

The electronic circuit breaker comprises an energy storage device which is electrically connected to the current path. The electronic circuit breaker is designed in such a way that when the electronic circuit breaker is arranged in a circuit for passing the load current through the current path of the control unit, a charge signal is transmitted, a change of which correlates with a change in the charge of the charged energy storage device. Using the charge signal, the control unit measures a discharge time when the energy storage device is discharged in the closed state of the switch, during which the energy storage device is continuously discharged. The control unit switches the switch to the open state when a limit value for the discharge time is exceeded, thereby preventing the formation of an arc fault in the circuit. The control unit receives the charge signal. The charge signal is a measurable and measured value of a physical quantity that correlates with the state of charge of the energy storage device and enables the control unit to determine whether the energy storage device is being charged or discharged during operation of the circuit.

An arc fault occurring in the circuit, in particular a series arc fault (SAF) in an electrical line connected to the input of the electronic circuit breaker, causes a drop in the input voltage Uᵢₙ of the electronic circuit breaker. The energy storage device counteracts the decreasing input voltage Uᵢₙ due to the discharge. If the detected discharge lasts longer than the limit value for the discharge time, the control unit disconnects the load from a voltage source of the circuit by switching the switch to the open state, i.e. by interrupting the current path, thereby preventing or immediately extinguishing the arc fault, in particular the series arc fault, that is present in the circuit.

In other words, the electronic circuit breaker distinguishes a series arc fault from operational fluctuations in the circuit based on the duration of the discharge. While operational fluctuations in the circuit usually result in very short discharges of the energy storage device, an arc fault, particularly a series arc fault, causes a relatively long discharge of the energy storage device.

The electronic circuit breaker can be designed as an integrated component comprising a housing in which all components of the electronic circuit breaker are arranged. Alternatively, components of the electronic circuit breaker can be distributed throughout the circuit and/or integrated into components of the circuit. For example, the energy storage device and the control unit on the one hand and the switch on the other hand can be arranged at opposite end sections of the electrical line. It is also possible for the electronic circuit breaker to be integrated into the load of the circuit.

The electronic circuit breaker is advantageously designed in such a way that the control unit continuously monitors the charge signal and determines, in particular measures, the discharge time in the event of a discharge of the energy storage device. In this way, the electronic circuit breaker reacts to the possible discharge of the energy storage device at any time during the operation of the circuit.

The load current is preferably a direct current (DC). Arc faults are particularly problematic in direct current systems. In contrast to alternating current (AC) voltage systems, the supply voltage U_{S} does not have a zero crossing at any time, which can cause an extinction of the series arc fault.

If the voltage source provides the supply voltage U_{S} as a direct voltage, the load current flows in the circuit as a direct current. Modern electrical direct current systems are increasingly being designed for higher supply voltages U_{S} in order to achieve greater energy efficiency. However, the higher the DC voltage provided, the higher the risk of a series arc fault. In addition, an arc fault that has arisen, in particular a series arc fault, persists in a DC voltage system.

The formation of an arc fault is expediently prevented when the switch is closed by discharging the energy storage device. During the intended operation of the circuit, the energy storage device of the electronic circuit breaker supports an operating voltage U_{A} of the load. Accordingly, the energy storage device can also be integrated into the load separately from the electronic circuit breaker. The support reduces a voltage drop between the voltage source and the electronic circuit breaker. The reduced voltage drop is less than an ignition voltage of the series arc.

In an advantageous development, the limit value for the discharge time is selected in such a way that the switch is switched to the open state even before an arc, in particular a series arc, forms. The limit value is specifically selected in such a way that the discharge occurring before the formation of the arc, in particular the series arc, already exceeds the limit value.

In an advantageous further development, the energy storage device is a capacitor or a battery. The capacitor may be provided as a supercapacitor or an electrolytic capacitor. The battery may be rechargeable, or non-rechargeable.

Advantageously, the electronic circuit breaker comprises a DC/DC converter which is arranged between the energy storage device and the current path. The DC/DC converter decouples the operating voltage Uₑ of the energy storage device from the supply voltage U_{S} of the voltage source. The DC/DC converter may have a wide operating range. The wide operating range enables better use of the electrical energy stored by the energy storage device.

The electronic circuit breaker expediently has an energy management unit which is arranged between the energy storage device and the current path. In particular, the energy management unit is designed in such a way that it allows the energy storage device to be discharged if a difference between the operating voltage Uₑ of the energy storage device, which is in particular normalized by means of a conversion factor, and the voltage Uᵢₙ at the input is greater than an upper difference threshold value. For discharging, the normalized operating voltage of the energy storage device must therefore be greater by the upper difference threshold value than the voltage at the input of the electronic circuit breaker, i.e. the input voltage of the electronic circuit breaker. The upper difference threshold may be 2 V, for example. In other words, the energy management unit starts discharging the energy storage device only upon a relevant drop in the input voltage.

The conversion factor has the value one if the operating voltage of the energy storage device is equal to the voltage at the input of the electronic circuit breaker. If the operating voltage of the energy storage device differs from the voltage at the input of the electronic circuit breaker, the conversion factor has a value other than one. The DC/DC converter can, for example, convert the voltage at the input of the electronic circuit breaker into an operating voltage of the energy storage device that is twice as high. In this case, the actual operating voltage of the energy storage device must be halved, i.e. divided by a conversion factor of two. The conversion factor corresponds in particular to the factor by which the DC/DC converter scales the voltage at the input of the electronic circuit breaker. The conversion factor corresponds in particular to the quotient of the operating voltage of the energy storage device and the voltage at the input of the electronic circuit breaker during normal operation.

The energy management unit is preferably designed in such a way that it blocks the energy storage device from discharging if the difference between the operating voltage Uₑ of the energy storage device, which is in particular normalized by means of the conversion factor, and the voltage Uᵢₙ at the input is less than a lower difference threshold value. For discharging, the normalized operating voltage of the energy storage device must exceed the input voltage of the electronic circuit breaker by at least the difference threshold. The lower difference threshold can be, for example, 0.3 V. In other words, the energy management unit stops discharging the energy storage device when the operating voltage of the energy storage device almost reaches the input voltage as a result of the discharge.

In particular, the energy management unit allows the energy storage device to be discharged as long as the difference between a supply voltage U_{S} of the circuit and the input voltage Uᵢₙ of the electronic circuit breaker is smaller than an arc fault limit value U_{SLBmin}. The arc fault limit value U_{SLBmin} can correspond to the sum of an offset value U_{offset} and the voltage drop value of the voltage drop between a voltage source generating the supply voltage and the input, where the offset value is in particular from 10V to 14V. The voltage drop value corresponds to the voltage drop on an electrical line with the line resistance R_{W} between the voltage source and the electronic circuit breaker, i.e. U_{SLBmin}=R_{W} Iᵢₙ.+U_{offset}, where Iᵢₙ is the input current of the electronic circuit breaker. The line resistance R_{W} can be measured or estimated.

The charge signal is preferably an operating voltage of the energy storage device or a discharge current of the energy storage device. The operating voltage Uₑ or the discharge current iₑ can be easily determined by the control unit.

In an advantageous further development, the limit value for the discharge time is from 5 ms to 25 ms, in particular from 10 ms to 20 ms. Limit values in the specified range are proven in practice.

An electrical circuit comprises a voltage source and a load. The voltage source is embodied, for example, as a DC voltage power supply or a bus of a DC voltage network. The load can also be referred to as an electrical consumer or resistive consumer.

The electrical circuit comprises an electronic circuit breaker as described above. The electronic circuit breaker is preferably arranged in the immediate vicinity of the load. The input of the electronic circuit breaker is connected to the voltage source. The output of the electronic circuit breaker is connected to the load. In particular, the electronic circuit breaker is arranged closer to the load than to the voltage source along a connecting line running from the voltage source to the load. Advantageously, a distance measured along the connecting line between the voltage source and the input is at least twice as large as a distance measured along the connecting line between the output and the load. In a further development, the electronic circuit breaker can comprise a plurality of inputs, a plurality of energy storage devices, a plurality of switches, and a plurality of outputs. I.e., the electronic circuit breaker can be designed as a multi-channel device. The electronic circuit breaker prevents the occurrence of an arc fault, particularly a series arc fault, in the circuit during operation of the circuit, thereby protecting the electrical line and/or the load from damage or destruction by the arc fault, particularly a series arc fault.

In one embodiment, the electrical circuit comprises an electrical line connecting the voltage source and the load, and the electronic circuit breaker is arranged in an end section of the electrical line away from the voltage source. In contrast to conventional electronic circuit breakers, the disclosed electronic circuit breaker (or arc fault circuit interrupter) is arranged at an end of the electrical line as a component of the circuit to be protected, as seen from the voltage source. In particular, the electronic circuit breaker is arranged closer to the load than to the voltage source along the electrical line. Advantageously, the electronic circuit breaker is arranged in a quarter of the electrical line that is furthest away from the voltage source.

In an advantageous further development, the electrical circuit comprises a higher-level electronic circuit breaker which is arranged between the voltage source and the electronic circuit breaker. The higher-level electronic circuit breaker is preferably located in the immediate vicinity of the voltage source. In particular, the higher-level electronic circuit breaker is arranged closer to the voltage source along the connecting line than the electronic circuit breaker. Advantageously, the higher-level electronic circuit breaker is integrated into the voltage source.

When the discharge time limit value is exceeded, the control unit may send a disconnection signal to the higher-level electronic circuit breaker to activate the higher-level electronic circuit breaker. The control unit may do so instead of switching the switch to the open state. As a result, the electronic circuit breaker is disconnected from the voltage source by the higher-level circuit breaker. The electronic circuit breaker and the higher-level circuit breaker together form a cascaded protection system. The two electronic circuit breakers are arranged in opposite end sections of the electrical line between the voltage source and the load. The electronic circuit breaker triggers the higher-level electronic circuit breaker. While the electronic circuit breaker operating as an arc fault circuit interrupter protects the electrical line and/or the load from, in particular, series arc faults, the higher-level electronic circuit breaker protects the electrical line and/or the load from parallel arc faults (PAF). The higher-level electronic circuit breaker also offers protection against an overload, a short circuit, or a ground fault.

Alternatively, the control unit can activate a chopper of the electronic circuit breaker. The electronic circuit breaker causes the chopper to create a short circuit. The higher-level electronic circuit breaker detects the short circuit generated by the chopper and then automatically disconnects the electrical line from the voltage source. In conjunction with the higher-level electronic circuit breaker, the electronic circuit breaker therefore also offers protection against parallel arc faults that are not detected by the higher-level electronic circuit breaker alone.

A method for preventing an arc fault, in particular a series arc fault, in a circuit by means of an electronic circuit breaker, the electronic circuit breaker having a current path which is looped into the circuit, has the following steps:

A charge signal is monitored, the change of which correlates with a change in the charge of a charged energy storage device of the electronic circuit breaker. When a discharge of the energy storage device is detected on the basis of the charge signal while the current path is closed, a discharge time during which the energy storage device is continuously discharged is determined, in particular measured. Advantageously, the discharge is detected by a control unit. Expediently, the determination, in particular the measurement, of the discharge time is carried out by means of the control unit. If a limit value for the discharge time is exceeded, the current path is opened. Expediently, the control unit causes the opening of the current path. In particular, a switch is arranged in the current path, which switch can be opened to open the current path, so that no load current can pass through the switch. Opening the current path prevents the formation of an arc, in particular a series arc, in the circuit. The method protects an electrical line connected to the input of the electronic circuit breaker and/or a load connected to an output of the electronic circuit breaker from damage or destruction by the arc fault, particularly the series arc fault.

### BRIEF DESCRIPTION OF THE DRAWINGS

An exemplary embodiment of the invention is explained below with reference to the drawings.

FIG. 1 shows an electrical circuit from the prior art.

FIG. 2 shows the electrical circuit shown in FIG. 1 with a series arc fault.

FIG. 3 shows a circuit diagram of an electronic circuit breaker operating as an arc fault interrupter.

FIG. 4 shows an electrical circuit with an electronic circuit breaker operating as an arc fault interrupter.

FIG. 5 shows the electrical circuit shown in FIG. 4 with arc faults.

FIG. 6 shows a flowchart of a method for protecting an electrical circuit from arc faults.

### DETAILED DESCRIPTION

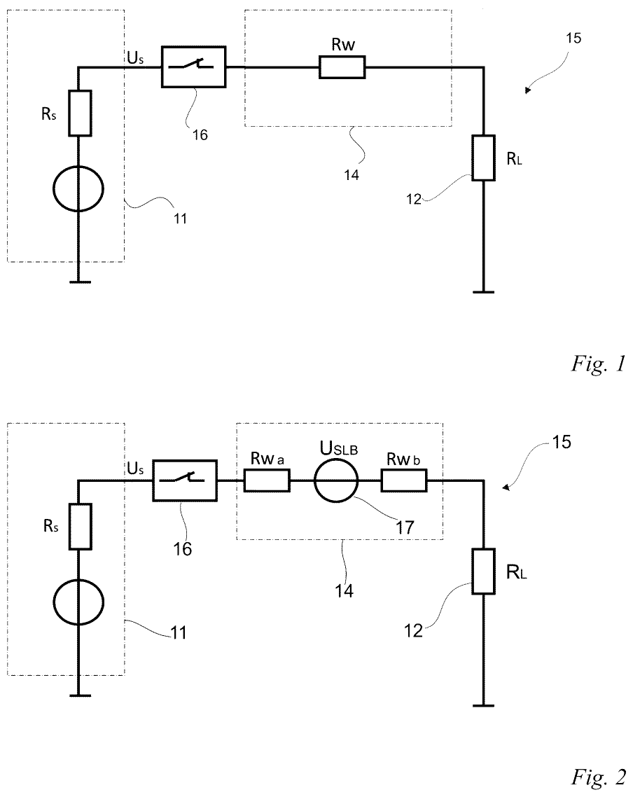

FIG. 1 shows a known electrical circuit 15. The electrical circuit 15 comprises a voltage source 11, an electrical line 14, a conventional electronic circuit breaker 16 and a load 12. The conventional electronic circuit breaker 16 is arranged in an end section of the electrical line 14 near the voltage source 11. The voltage source 11 has an internal resistance R_{S} and provides a supply voltage U_{S}. The electrical line 14 has a line resistance R_{W}. The load 12 has a load resistance R_{L}. During normal operation of the electrical circuit 15, the electronic circuit breaker 16 is in a closed state and connects the load 12 to the voltage source 11 and allows a load current to flow.

FIG. 2 shows the electrical circuit 15 shown in FIG. 1 with a series arc fault 17, which has arisen, for example, as a result of a break in the electrical line 14. The point of the break divides the line resistance R_{W} into a first line partial resistance R_{Wa} between the voltage source 11 and the break point and a second line partial resistance R_{Wb} between the break point and the load 12, where R_{W}=R_{Wa}+R_{Wb}. At the breakage point, an arc fault voltage drop U_{SLB} maintains the series arc 17. The conventional electronic circuit breaker 16 does not detect the arc fault voltage U_{SLB} and, as a result, the series arc fault 17. As a result, the circuit breaker 16 does not go into an open state and does not disconnect the load 12 from the voltage source 11. The load current continues to flow through the electronic circuit breaker 16 and is modulated by the series arc fault 17. That can cause damage to the electrical line 14 or the load 12 or even to destruction of the electrical line 14 or the load 12. Apart from that, the series arc 17 can cause a fire.

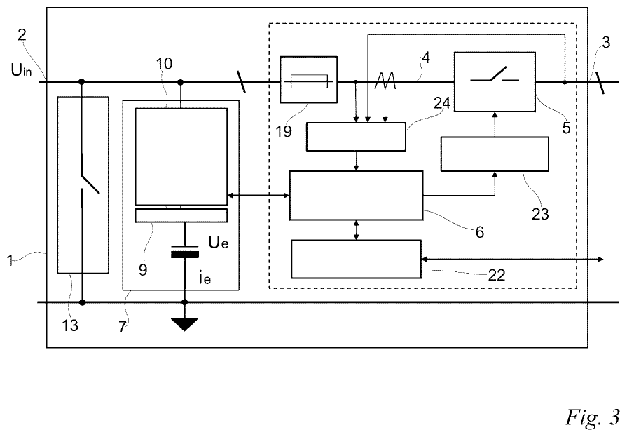

FIG. 3 shows an electronic circuit breaker 1 for arc fault interruption. The electronic circuit breaker 1 for arc fault interruption can be arranged in the electrical circuit 15 shown in FIGS. 1 and 2 instead of the conventional electronic circuit breaker 16. The description of FIGS. 1 and 2 therefore also applies to an electrical circuit with arc fault interruption. The electronic circuit breaker 1 for arc fault interruption has an input 2 and an output 3. A current path 4 for a load current connects the input 2 to the output 3. The load current can be a direct current. An input voltage present at the input 2 is denoted by Uᵢₙ.

A switch 5 is arranged in the current path 4. The switch 5 has a closed state and an open state. In the open state, the current path 4 is open and no load current can flow. In the closed state, the current path 4 is closed and allows the load current to flow. The switch 5 is used to selectively interrupt and close the current path 4.

The electronic circuit breaker 1 comprises a control unit 6. The control unit 6 is configured to switch the switch 5 between the open state and the closed state.

The electronic circuit breaker 1 comprises an energy storage device 7 which is electrically connected to the current path 4. The energy storage device 7 may be a capacitor or a rechargeable battery. An operating voltage provided by the energy storage device 7 is denoted by Uₑ. A current flowing during a charge change of the energy storage device 7 is denoted by iₑ. The electronic circuit breaker 1 is designed in such a way that the energy storage device 7 can be discharged and/or charged during the intended operation of the electronic circuit breaker 1, in particular when the current path 4 is closed, in particular when the switch 5 is in the closed state.

The electronic circuit breaker 1 is designed in such a way that when the electronic circuit breaker 1 is arranged in a circuit 8 for passing the load current through the current path 4, a charge signal is transmitted to the control unit 6. A change of the charge signal correlates with a change in the charge of the energy storage device 7. The charge signal can be an operating voltage of the energy storage device 7 or a discharge current of the energy storage device 7. The charge signal is monitored during the operation of the electronic circuit breaker 1, i.e. when the load is supplied with the load current. In particular, the charge signal is permanently monitored.

The electronic circuit breaker 1 is further designed such that the control unit 6 determines a discharge time when the energy storage device 7 is discharged. This is achieved by using the charge signal while the switch 5 is closed. In the exemplary embodiment the control unit 6 measures the time during which the energy storage device 7 is continuously discharged. The control unit 6 then switches the switch 5 to the open state when a limit value for the discharge time is exceeded.

The limit value for the discharge time is selected in particular in such a way that the switch 5 is switched to the open state even before an arc forms, in particular a series arc. Specifically, the limit value for the discharge time can be from 5 ms to 25 ms, in particular from 10 ms to 20 ms. This prevents the formation of an arc, in particular a series arc, in the circuit 8.

In addition, the formation of an arc, in particular a series arc, can be prevented when the switch 5 is closed by discharging the energy storage device 7.

The electronic circuit breaker 1 can be designed such that the control unit 6 continuously monitors the charge signal and determines, in particular measures, the discharge time in the event of a discharge of the energy storage device 7.

Furthermore, the electronic circuit breaker 1 can comprise a DC/DC converter 9 which is arranged between the energy storage device 7 and the current path 4.

The electronic circuit breaker 1 has, in particular, an energy management unit 10 which is arranged between the energy storage device 7 and the current path 4. The energy management unit 10 can be designed in such a way that it allows the energy storage device 7 to be discharged if a difference between the operating voltage of the energy storage device 7 and the input voltage at the input 2, which is in particular normalized by means of a conversion factor, is greater than an upper difference threshold value. The energy management unit 10 can also be designed in such a way that it blocks the energy storage device 7 from discharging, if the difference between the operating voltage of the energy storage device 7, which is in particular normalized by means of a conversion factor, and the input voltage at the input 2 is less than a lower difference threshold value. In particular, the DC/DC converter allows the energy storage device 7 to be discharged during operation of the electronic circuit breaker 1, in particular when the current path 4 is closed.

In particular, the energy management unit 10 allows the energy storage device 7 to be discharged as long as the difference between a supply voltage of the circuit 8 and the input voltage of the electronic circuit breaker 1 is smaller than an arc fault limit value. The arc fault limit value ideally corresponds to the sum of an offset value and the voltage loss value of the voltage loss between a voltage source 11 generating the supply voltage and the input 2. The offset value is specifically from 10 V to 14 V.

The electronic circuit breaker 1 may also include a chopper 13 and/or a fuse 19. The fuse 19 may be provided to comply with an applicable safety standard.

The electronic circuit breaker 1 can also comprise a communication module 22 and/or a measuring module 24, which are operatively connected to the control unit 6. The communication module 22 is designed to transmit a state of the electronic circuit breaker 1 and/or the circuit 8 to a central control system (not shown). The measuring module 23 is designed to detect a state of the circuit 8 by measuring the load current or an input voltage Uᵢₙ. The electronic circuit breaker 1 can further comprise a control module 23 which is operatively connected to the control unit 6 and the switch 5. The control module 23 is designed to open or close the switch 5 depending on a signal from the control unit 6.

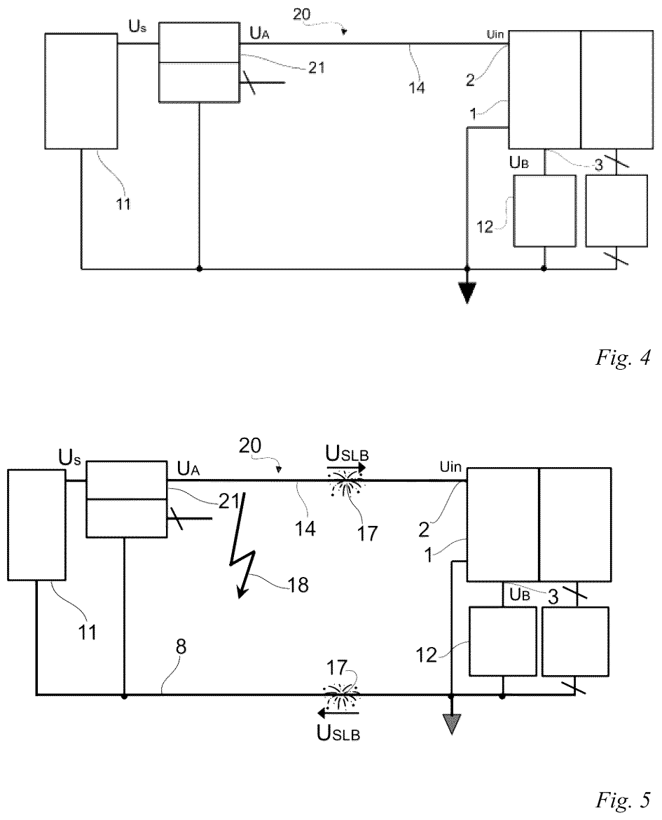

FIG. 4 shows a electrical circuit 20 according to the invention. The electrical circuit 20 comprises a voltage source 11 and a load 12. The electrical circuit 20 further comprises the electronic circuit breaker 1 shown in FIG. 3. The input 2 of the electronic circuit breaker 1 is connected to the voltage source 11 via an electrical line. The output 3 of the electronic circuit breaker 1 is connected to the load 12. The electronic circuit breaker 1 can be arranged in an end section of the electrical line away from the voltage source 11. In particular, the electronic circuit breaker 1 is arranged along the electrical line closer to the load 12 than to the voltage source 11. Advantageously, the electronic circuit breaker 1 is arranged in a quarter of the electrical line that is furthest away from the voltage source 11.

The electrical circuit 20 further comprises a higher-level electronic circuit breaker 21, which can be designed as a conventional electronic circuit breaker 16 (see FIGS. 1 and 2) and is arranged between the voltage source 11 and the electronic circuit breaker 1. The higher-level electronic circuit breaker 21 can be arranged in an end section of the electrical line near the voltage source 11. In particular, the higher-level electronic circuit breaker 21 is arranged along the electrical line closer to the voltage source 11 than to the load 12. Advantageously, the higher-level electronic circuit breaker 21 is arranged in a quarter of the electrical line that is furthest away from the load 12. When the discharge time limit value is exceeded, the control unit 6 can send a disconnection signal to the higher-level electronic circuit breaker 21 to activate the higher-level electronic circuit breaker 21, in particular instead of switching the switch 5 to the open state. Thereby, the electronic circuit breaker 1 is disconnected from the voltage source 11 by the higher-level circuit breaker 21.

Alternatively or additionally, the control unit 6 activates the chopper 13 of the electronic circuit breaker 1, in particular instead of switching the switch 5 shown in FIG. 3 to the open state, whereby the higher-level electronic circuit breaker 21 detects an overload case and disconnects the electronic circuit breaker 1 from the voltage source 11.

By means of the electronic circuit breaker 1, the current path 4 of which is looped into the circuit 8, an arc fault, in particular a series arc fault, in the circuit 8 is prevented in a method as follows.

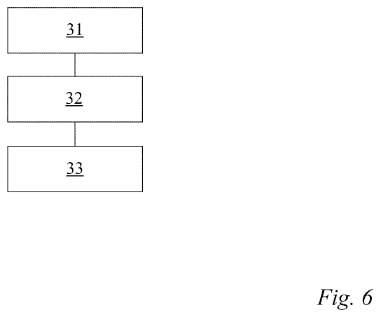

In a first method step designated by the reference numeral 31 in FIG. 6, a charge signal is monitored. A change of the charge signal correlates with a charge change of the energy storage device 7 of the electronic circuit breaker 1. In the exemplary embodiment, the monitoring is carried out by the control unit 6 as described above.

In a second method step designated by the reference numeral 32 in FIG. 6, when the energy storage device 7 is discharged, as indicated by the charge signal while the current path 4 is closed, a discharge time is determined, in particular measured, during which the energy storage device 7 is continuously discharged. In the exemplary embodiment, the determination, in particular the measurement, of the discharge time is carried out by the control unit 6.

In a third method step designated by the reference numeral 33 in FIG. 6, the current path 4 is opened when the limit value for the discharge time is exceeded, thereby preventing the formation of an arc, in particular a series arc, in the circuit 8. In the exemplary embodiment, the opening of the current path 4 is caused by the control unit 6. As described above, the switch 5 is advantageously transferred to the open state.

In addition, the formation of an arc fault, in particular a series arc fault, can be prevented by discharging the energy storage device 7.

FIG. 5 shows the electrical circuit 20 shown in FIG. 4. Thanks to the electronic circuit breaker 1, the electrical circuit 20 protects the electrical line 14 and/or the load 12 from series arc faults 17 in the electrical line 14, both in a forward line and in a return line, or from a parallel arc fault 18 between the forward line and the return line. The series arcs 17 are each associated with a fault arc voltage U_{SLB}. The electronic circuit breaker 1 prevents the occurrence of series arc 17 by isolating the load 12 from the voltage source 11. The higher-level electronic circuit breaker 21 also detects the parallel arc fault 18 and causes the higher-level electronic circuit breaker 21 to disconnect the electrical line 14 from the voltage source 11, thereby extinguishing the parallel arc fault 18.

What is claimed is:

1. An electronic circuit breaker, comprising:
an input (2);
an output (3);
a current path (4) for a load current connecting the input (2) to the output (3);
a switch (5) having a closed state and an open state arranged in the current path (4),
wherein in the open state the current path (4) is open and blocks the load current, and
wherein in the closed state the current path (4) is closed and allows the load current to flow;
a control unit (6) configured to switch the switch (5) between the open state and the closed state; and
an energy storage device (7) electrically connected to the current path (4),
wherein the control unit (6) is configured to receive a charge signal,
wherein the charge signal correlates with a change in a charge of the energy storage device (7),
wherein the control unit (6) measures a discharge time during which the energy storage device (7) is continuously discharged based on the charge signal while the switch (5) is in the closed state, and
wherein the control unit (6) switches the switch (5) to the open state when a limit value for the discharge time is exceeded, thereby preventing formation of an arc in a circuit (8) when the electronic circuit breaker (1) is arranged in the circuit (8) for passing the load current through the current path (4).

2. The electronic circuit breaker according to claim 1,
wherein the control unit (6) continuously monitors the charge signal and determines the discharge time in case of a discharge of the energy storage device (7).

3. The electronic circuit breaker according to claim 1,
wherein the load current is a direct current.

4. The electronic circuit breaker according to claim 1,
wherein the formation of the arc is prevented by discharging the energy storage device (7).

5. The electronic circuit breaker according to claim 1,
wherein the limit value for the discharge time is selected in such a way that the switch (5) is switched to the open state before the arc can form.

6. The electronic circuit breaker according to claim 1,
wherein the energy storage device (7) is a capacitor or a rechargeable battery.

7. The electronic circuit breaker according to claim 1,
further comprising a DC/DC converter (9) which is arranged between the energy storage device (7) and the current path (4).

8. The electronic circuit breaker according to claim 1,
further comprising an energy management unit (10) which is arranged between the energy storage device (7) and the current path (4),
wherein the energy management unit (10) allows the energy storage device (7) to be discharged if a difference between an operating voltage of the energy storage device (7) and a voltage at the input (2) is greater than an upper difference threshold value.

9. The electronic circuit breaker according to claim 8,
wherein the operating voltage of the energy storage device (7) is normalized by a conversion factor.

10. The electronic circuit breaker according to claim 8,
wherein the energy management unit (10) blocks discharging of the energy storage device (7) if the difference between the operating voltage of the energy storage device (7) and the voltage at the input (2) is less than a lower difference threshold value.

11. The electronic circuit breaker according to claim 10,
wherein the operating voltage of the energy storage device (7) is normalized by a conversion factor.

12. The electronic circuit breaker according to claim 8,
wherein the energy management unit (10) allows the energy storage device (7) to be discharged as long as the difference between a supply voltage of the circuit (8) and an input voltage of the electronic circuit breaker (1) is smaller than an arc fault limit value,
wherein the arc fault limit value corresponding to a sum of an offset value and a voltage loss between a voltage source (11) generating the supply voltage and the input (2).

13. The electronic circuit breaker according to claim 12,
wherein the offset value is from 10V to 14V.

14. The electronic circuit breaker according to claim 1,
wherein the charge signal is a voltage of the energy storage device (7) or a discharge current of the energy storage device (7).

15. The electronic circuit breaker according to claim 1,
wherein the limit value for the discharge time is from 5 ms to 25 ms.

16. The electronic circuit breaker according to claim 1,
wherein the limit value for the discharge time is from 10 ms to 20 ms.

17. An electrical circuit, comprising:
a voltage source (11);
a load (12); and
an electronic circuit breaker (1), comprising
an input (2) connected to the voltage source (11);
an output (3) connected to the load (12);
a current path (4) for a load current connecting the input (2) to the output (3);
a switch (5) having a closed state and an open state arranged in the current path (4),
wherein in the open state the current path (4) is open and blocks the load current, and
wherein in the closed state the current path (4) is closed and allows the load current to flow;
a control unit (6) configured to switch the switch (5) between the open state and the closed state; and
an energy storage device (7) electrically connected to the current path (4),
wherein the control unit (6) is configured to receive a charge signal,
wherein the charge signal correlates with a change in a charge of the energy storage device (7),
wherein the control unit (6) measures a discharge time during which the energy storage device (7) is continuously discharged based on the charge signal while the switch (5) is in the closed state, and
wherein the control unit (6) switches the switch (5) to the open state when a limit value for the discharge time is exceeded, thereby preventing formation of an arc in the electrical circuit.

18. The electrical circuit according to claim 17,
wherein the electrical circuit (20) comprises an electrical line connecting the voltage source (11) and the load (12), and the electronic circuit breaker (1) is arranged in an end section of the electrical line away from the voltage source.

19. The electrical circuit according to claim 17,
further comprising a higher-level electronic circuit breaker (21) which is arranged between the voltage source (11) and the electronic circuit breaker (1),
wherein the control unit (6) sends a disconnection signal to the higher-level electronic circuit breaker (21) when the limit value for the discharge time is exceeded and thereby activates the higher-level electronic circuit breaker (21), as a result of which the electronic circuit breaker (1) is disconnected from the voltage source (11) by the higher-level electronic circuit breaker (21), or
wherein the control unit (6) activates a chopper (13) of the electronic circuit breaker (1), whereby the higher-level electronic circuit breaker (21) detects an overload and disconnects the electronic circuit breaker (1) from the voltage source (11).

20. An electrical circuit, comprising:
a voltage source (11);
a load (12); and
an electronic circuit breaker (1), comprising
an input (2) connected to the voltage source (11);
an output (3) connected to the load (12);
a current path (4) for a load current connecting the input (2) to the output (3);
a switch (5) having a closed state and an open state arranged in the current path (4),
wherein in the open state the current path (4) is open and blocks the load current, and
wherein in the closed state the current path (4) is closed and allows the load current to flow;
a control unit (6) configured to switch the switch (5) between the open state and the closed state; and
an energy storage device (7) electrically connected to the current path (4),
wherein the control unit (6) is configured to receive a charge signal,
wherein the charge signal correlates with a change in a charge of the energy storage device (7),
wherein the control unit (6) measures a discharge time during which the energy storage device (7) is continuously discharged based on the charge signal while the switch (5) is in the closed state; and
a higher-level electronic circuit breaker (21) arranged between the voltage source (11) and the electronic circuit breaker (1),
wherein the control unit (6) sends a disconnection signal to the higher-level electronic circuit breaker (21) to activate the higher-level electronic circuit breaker (21) when a limit value for the discharge time is exceeded, as a result of which the electronic circuit breaker (1) is disconnected from the voltage source (11) by the higher-level electronic circuit breaker (21), or
wherein the control unit (6) activates a chopper (13) of the electronic circuit breaker (1) when the limit value for the discharge time is exceeded, whereby the higher-level electronic circuit breaker (21) detects an overload and disconnects the electronic circuit breaker (1) from the voltage source (11).
